(19) United States
(12) Patent Application Publication
(10) Pub. No.: US 2008/0153710 A1
(43) Pub. Date: Jun. 26, 2008

(54) Analysis unit, biosensor and method for detecting or determining the concentration of an analyte

(76) Inventors: Arne Hengerer, Erlangen (DE); Rainer Kuth, Hochstadt (DE)

Correspondence Address: HARNESS, DICKEY & PIERCE, P.L.C., P.O.BOX 8910, RESTON, VA, 20195, US

(21) Appl. No.: 11/797,428

(22) Filed: May 3, 2007

(30) Foreign Application Priority Data
May 4, 2006 (DE) 10 2006 020 866.8

(51) Int. Cl. C40B 20/08; C40B 60/10; G06G 7/48

(52) U.S. Cl. 506/6; 506/38; 703/11

(57) ABSTRACT

A biosensor includes an analysis unit and a reader device for detecting an analyte. In at least one embodiment, the analysis unit includes a quartz oscillator on whose surface capture molecules, which bind specifically to the analyte, are immobilized; as well as a transponder to transmit information, regarding whether and/or how many analyte molecules have bound to the capture molecules, to the reader device.

### PRIORITY STATEMENT

The present application hereby claims priority under 35 U.S.C. §119 on German patent application number DE 10 2006 020 866.8 filed May 4, 2006, the entire contents of which is hereby incorporated herein by reference.

### FIELD

Embodiments of the invention generally relate to an analysis unit for detecting or determining the concentration of an analyte. For example, in at least one embodiment, the analysis unit has at least one sensor with a quartz oscillator on whose surface capture molecules which bind specifically to the analyte are immobilized, the natural frequency of the quartz oscillator depending on whether and/or how many analyte molecules are bound to the capture molecules. Embodiments of the invention furthermore generally relate to a biosensor which contains such an analysis unit and a reader device, and/or to a corresponding method for detecting or determining the concentration of an analyte.

### BACKGROUND

Biosensors in the form of microarrays are known in the prior art, with which various biopolymers and in particular DNA sequences can be detected. A microarray is a substrate with capture molecules applied or immobilized thereon in individual “spots”, which bind specifically to a respectively intended molecule. For DNA analysis, for example, the capture molecules may be oligonucleotides which hybridize with a sequence complementary thereto.

If such a microarray is brought in contact with a sample, then the intended DNA molecules bind to their complementary capture molecules. These bindings can be detected by conventional methods/apparatuses, for example through fluorescence or radioactivity. To this end, the molecules to be detected (analyte) must generally be marked with corresponding radioactive or fluorophoric marker substances. Various types of such biosensors are described, for example, in the article “Bioactive Films” by A. Hengerer et al., Materials Science Forum No. 287. 288 (1998), pages 169 to 178.

The microarray—generally referred to as an “analysis device”—thus emits a signal (for example electrically or optically) when the analyte interacts with a capture molecule, which can be recorded and optionally interpreted by a corresponding so-called “reader device”. To this end, direct contact between the analysis unit and the reader device is necessary. For example, the analysis unit is fitted into a recess of the reader device.

While analysis units are often single-use products and can be produced inexpensively, the reader devices usually need to be equipped with expensive optics and/or electronics. For widespread use of biosensors, particularly in medical diagnosis, for detecting biological warfare agents, for environmental and food analysis, hospital hygiene and bioprocess technology, it would be desirable if a reader device were not required in situ. It is admittedly possible for the sample with the analyte to be detected to be transported to a central laboratory facility where a corresponding reader device is available. Yet, since biological i.e. perishable samples such as serum, food etc. are often involved, this entails considerable logistics, for example to maintain a cold chain, and/or measures for sample stabilization.

It is also known to produce biosensors in which the capture molecules are fixed on the surface of a quartz oscillator. A quartz oscillator has piezoelectric properties, i.e. a mechanical deformation of the quartz can be achieved by applying an electrical voltage. If an alternating electrical field is applied, then oscillations take place within the quartz at a characteristic natural frequency; resonance occurs. Accumulations of mass on the quartz change the oscillation frequency. Thus, accumulation of the analyte to be detected on the capture molecules can be detected by a change in the natural frequency. For instance, the resonant frequency decreases owing to accumulation of an analyte by affine interaction with a capture molecule on the quartz surface.

This discovery forms the theoretical basis of the quartz micro-balance technique. The relationship between absorbed mass and natural frequency is in this case described by Sauerbrey's formula. The advantage of these micro-balances is then extremely fine sensitivity in the nanogram range. The technique of such micro-balances has also been used for some time in chemical or biological sensors, as described for example in the article “Quartz Balance DNA Sensor” by C. Nicolini et al., Biosence Bioelectron. 1997; 12(7), pages 613 to 618.

### SUMMARY

In at least one embodiment of the invention, a device and/or a method are provided for detecting or determining the concentration of an analyte, which does not present at least one of the aforementioned disadvantages and in at least one embodiment, does not require the presence of a reader device at the place where the sample is taken, for example at the “point of care” in a medical practice.

According to at least one embodiment of the invention, the analysis unit includes a transponder for wireless information interchange with a reader device. The transponder is electrically connected to the quartz oscillator and is designed to transmit information, regarding whether and/or how many analyte molecules have bound to the capture molecules, to the reader device. Thus, the reader device communicates with the analysis unit merely using electromagnetic waves, so that even sizeable distances between them can be covered. At least one embodiment of the invention in this case utilizes the recent development of biosensors with quartz crystals, in which the binding of the analytes to the capture molecules is detected by a change in the natural frequency.

A transponder, also referred to as an RFID tag, is a communication device which receives incoming signals and automatically responds to them. The term transponder is a contraction of the terms “transmitter” and “responder”. Transponders are used, for example, in order to identify aircraft: the transponder installed in the aircraft receives an encoded signal from a transmission-reception unit located at the control center, and responds to the signal at a predetermined frequency with the required data, for example a set transponder code and the flight altitude.

The transponder according to at least one embodiment of the invention is configured to receive information from a reader device and send corresponding data, for example information regarding the binding of analyte molecules onto the sensor surface, back to the reader device.

According to a particular example embodiment, the transponder is passive. The term passive transponders refers to systems which take the energy, needed for communication and running internal processes, exclusively from the field of the transmission-reception unit (here the reader device). Passive transponders thus operate powerlessly. The analysis units equipped with such transponders can therefore be produced less expensively and are suitable as a disposable product.

Active transponders which have their own power supply, for example in the form of a battery, are nevertheless also possible. With active transponders, larger communication ranges are possible.

The transponder preferably includes a microchip and an antenna. These may, for example, be integrated into a package.

The transponder functions in the following way, for example: The reader device generates an electromagnetic radiofrequency (RF) or ultrahigh frequency (UHF) field, which the antenna of the transponder receives. An induction current is thereby set up in the antenna coil. This activates the microchip in the transponder. In the case of passive transponders, the induced current furthermore charges a capacitor which provides a constant power supply for the chip. In the case of active transponders, this is done by a built-in battery.

Once the microchip is activated, it receives from the reader device the command to excite the quartz oscillator in a particular way, particularly preferably directly with a frequency transmitted by the reader device. Nevertheless, embodiments are also conceivable in which the microchip generates the alternating electrical field for exciting the quartz oscillator with another frequency. The queried information regarding the binding of analyte molecules is transmitted to the reader device by the transponder, in that it modulates a response into the field emitted by the reader device. In this case the transponder merely modifies the electromagnetic field of the reader device, for example by so-called load modulation.

In one embodiment of the invention, a frequency spectrum is transmitted which contains the natural frequencies of the quartz oscillator, or a plurality of quartz oscillators, both with and without analyte molecules bound to the capture molecules. In this way, quantitative inferences are possible regarding the state of occupancy of the sensor surface and therefore regarding the analyte concentration in the sample.

According to a particular example embodiment, the sensor includes at least three quartz oscillators, the first quartz oscillator being coated with first control molecules whose molecular weight corresponds to that of the capture molecules, the second quartz oscillator being coated with second control molecules whose molecular weight corresponds to a complex of a capture molecule and an analyte molecule, and the third quartz oscillator being coated with capture molecules. This permits accurate calibration of the natural frequency of the third quartz oscillator—the sensor surface per se—since the first quartz oscillator serves as a negative control, because it should have the same frequency as the third quartz oscillator when no analyte molecules are bound to the capture molecules. The second quartz oscillator, on the other hand, serves as a positive control since it has the same mass as the third quartz oscillator when many analyte molecules are bound to the latter.

A separate transponder may be provided for each of the three quartz oscillators.

According to another embodiment of the invention, which may also be combined with that described above, the analysis unit includes a plurality of sensors which are respectively specific to different analytes. For example, the analysis unit may be configured as a microarray with many spots.

The capture molecules are preferably biopolymers, in particular nucleic acids, proteins, peptides, polysaccharides, antibodies or antibody fragments. As an alternative, synthetic binding molecules (affibodies), viruses or bacteria may also be applied as capture molecules. The term “capture molecules” is also intended to cover larger structures, such as viruses and bacteria. If sterically necessary, the binding to the sensor surface may also take place via a linker. It may be non-covalent or covalent, corresponding binding strategies being described for example in the article by A. Hengerer cited above. In this way, according to an example embodiment, peptides or proteins may be linked via a gold surface (binding of cysteine to gold). A simple washing step may possibly need to be carried out. This may be done inductively.

At least one embodiment of the invention furthermore concerns a biosensor which, besides the analysis unit described above, also includes a corresponding reader device for information interchange with the transponder of the analysis unit by way of electromagnetic waves. As mentioned above, the analysis unit is preferably located in a central laboratory facility. As an alternative, it may also be installed at the place where the sample is taken.

This embodiment also offers considerable advantages of the invention, since contactless reading of the analysis unit is possible. One possible application resides, for example, in putting an analysis unit, whose sensor is coated with biological (macro)molecules which are specific to breakdown products of a medicament or to contaminations, in the packaging of the medicament. When the medicament leaves the pharmacist or the wholesaler, the medicament packaging passes through a reader unit and is checked. At least one embodiment of the invention thus has the advantage that elaborate opening and examination of the packaging is not necessary. The analysis unit is in this case advantageously designed as a disposable product.

According to an example embodiment, the reader device includes an antenna by which an electromagnetic RF or UHF field can be generated, which can be received by the antenna of the transponder. The reader device preferably operates in the UHF range, at about 0.3 to 3 GHz. This radiation has a long range. As an alternative, however, it is also conceivable for the reader device to lie in closer proximity to the analysis unit, so that electromagnetic waves in the RF range, for example between 10 kHz and 1 MHz, may then also be used. It is particularly preferable for the frequency to correspond at least approximately to the natural frequency of the quartz oscillator in the sensor of the analysis unit, so that energy transmitted by the reader device can be used directly for exciting the quartz oscillator.

Lastly, at least one embodiment of the invention also concerns a method for detecting or determining the concentration of an analyte by using the biosensor described above, which comprises the following steps: the quartz oscillator of the analysis unit is brought in contact with a sample to be examined; the transponder is activated by a UHF electromagnetic field generated by the reader device and the quartz oscillator is excited to oscillate; the impedance of the quartz oscillator is determined; and information regarding the impedance, and therefore regarding whether and/or how many analyte molecules have bound to the capture molecules on the quartz oscillator, is transmitted via the antenna of the transponder to the reader device

As described above, the detection per se is based on accurately establishing the resonant frequency of the quartz oscillator. This may be done by measuring the impedance of the quartz oscillator (when the quartz crystals are excited by an alternating field with known frequency).

### BRIEF DESCRIPTION OF THE DRAWINGS

The invention will now be described in more detail with the aid of example embodiments with reference to the appended drawings. In the drawings:

FIG. 1 shows a schematic cross section through an analysis device according to a first embodiment of the invention;

FIG. 2 shows a schematic plan view of a biosensor according to the first embodiment;

FIG. 3 shows a schematic cross section through an analysis device according to a second embodiment of the invention;

FIG. 4 shows a schematic view of the occupancy of the quartz crystals according to the second embodiment.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described. Like numbers refer to like elements throughout. As used herein, the term “and/or” includes any and all combinations of one or more of the associated listed items.

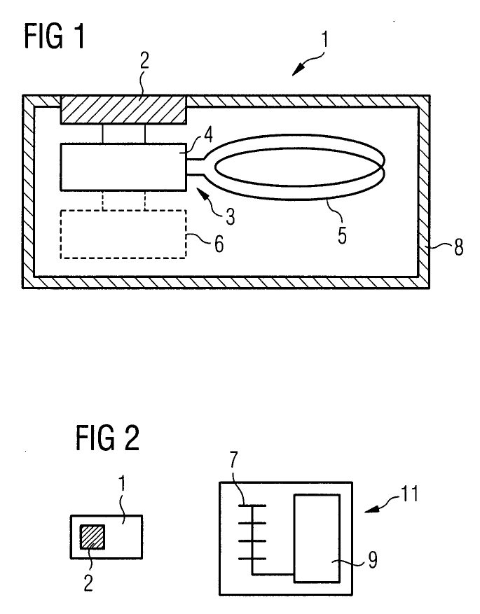

FIG. 1 shows, schematically and on a very enlarged scale, a cross section through an analysis device according to one embodiment of the invention. It includes a wafer of piezoelectric quartz crystals 2, i.e. a quartz oscillator 2, whose surface is coated with suitable capture molecules (not shown). The quartz oscillator 2 is integrated into a package 8, which preferably consists of plastic. The quartz oscillator 2 is electrically connected to a microchip 4, to which an antenna 5 is in turn attached. The antenna 5 is represented here as a coil with two turns, although many other suitable antenna designs are known to the person skilled in the art. The microchip 4 and the antenna 5 together form a transponder 3.

If the transponder is an active transponder, then a battery or a cell 6 is furthermore provided. Since this is an optional feature, the battery 6 is represented by dashes.

FIG. 2 shows the analysis device 1 of FIG. 1 together with a corresponding reader device 11. This likewise includes an antenna 7 as well as an electronics module 9. The electronics module 9 contains all the components which are necessary for the reader device to function, i.e. for example a frequency generator, amplifier, processor, and optionally a display device and input device such as a keyboard or mouse. As an alternative, the reader device 11 may also be attached to a PC.

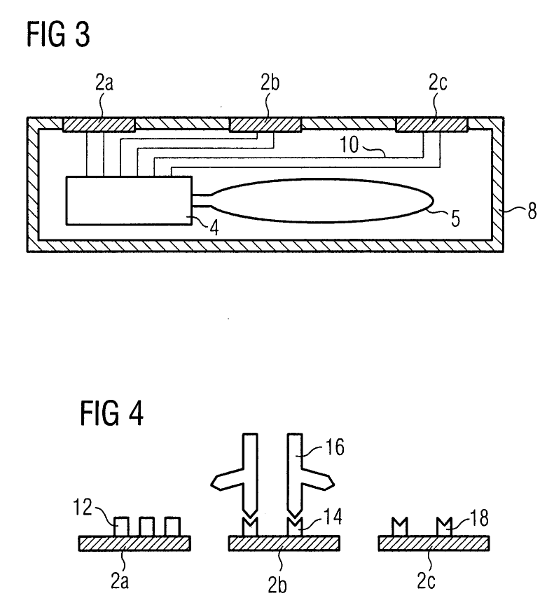

FIG. 3 represents the embodiment with three quartz oscillators 2a, 2b and 2c. As illustrated in FIG. 4, the first quartz oscillator 2a is coated with molecules 12 which have the same molecular weight as the capture molecules 18 per se, but which are non-functional i.e. analyte molecules cannot bind to them. The second quartz oscillator 2b is coated with a stable (for example covalent) complex of a capture molecule 14 and the analyte 16 in question. As an alternative, however, loading with a similar molecular weight may also be provided. The third quartz element 2c has the sensor surface per se, and is therefore coated with capture molecules 18.

The functionality of this embodiment is as follows: Using a reader device 11, the analysis units are excited to resonance. Two different frequencies are used for this: one for exciting the quartz oscillators 2a, 2b, 2c coated only with capture molecules 12, 18, and one for exciting the quartz oscillators 2a, 2b, 2c coated with a complex 14, 16 of capture molecule and analyte. The analysis unit is therefore supplied with electrical energy as a function of the occupancy, and transmits the content of a memory, located in the microchip 4, back via the same antenna 5 to the reader device 11 for identification.

According to the embodiment of FIG. 3, all the quartz oscillators 2a, 2b and 2c are attached via electrical lines 10 to a single transponder. As an alternative, however, each quartz oscillator many have its own transponder 3 with a microchip 4 and an antenna 5.

At least one embodiment of the invention has the advantage that the binding between two biologically relevant molecules can be recorded, optionally quantitatively, no elaborate separation steps being required. The use of markers, for example radioactive elements or fluorophoric groups, may also be obviated. The time and equipment outlay can therefore be reduced considerably.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An analysis unit for at least one of detecting and determining the concentration of an analyte, the analysis unit comprising:
at least one sensor with a quartz oscillator, on whose surface capture molecules which bind specifically to the analyte are immobilized, a natural frequency of the quartz oscillator depending on at least one of whether and how many analyte molecules are bound to the capture molecules; and
a transponder for wireless information interchange with a reader device, electrically connected to the quartz oscillator and designed to transmit information to the reader device, regarding at least one of whether and how many analyte molecules have bound to the capture molecules, the at least one sensor including three quartz oscillators, the first quartz oscillator being coated with first control molecules whose molecular weight corresponds to that of the capture molecules, the second quartz oscillator being coated with second control molecules whose molecular weight corresponds to a complex of a capture molecule and an analyte molecule, and the third quartz oscillator being coated with capture molecules.

2. The analysis unit as claimed in claim 1, wherein the transponder is passive.

3. The analysis unit as claimed in claim 1, wherein the transponder is active and includes a power supply.

4. The analysis unit as claimed in claim 1, wherein the transponder comprises a microchip and an antenna.

5. The analysis unit as claimed in claim 1, wherein the analysis unit comprises a separate transponder for each of the three quartz oscillators.

6. The analysis unit as claimed in claim 1, wherein the analysis unit comprises a plurality of sensors, on whose quartz oscillators capture molecules which are specific to different analytes are respectively immobilized.

7. The analysis unit as claimed in claim 1, wherein the capture molecules are biopolymers, in particular nucleic acids, proteins, peptides, polysaccharides, antibodies or antibody fragments, or viruses or bacteria.

8. A biosensor for at least one of detecting and determining the concentration of an analyte, comprising:
an analysis unit as claimed in claim 1; and
a reader device, to interchange information with the transponder of the analysis unit via electromagnetic waves.

9. The biosensor as claimed in claim 8, wherein the reader device includes an antenna, by which electromagnetic waves are generateable whose frequency corresponds at least approximately to the natural frequency of the quartz oscillators.

10. The biosensor as claimed in claim 9, wherein the electromagnetic waves have a frequency spectrum which contains the natural frequencies of the quartz oscillators both with and without analyte molecules bound to the capture molecules.

11. The biosensor as claimed in claim 8, wherein the reader device comprises an antenna by which at least one of an electromagnetic RF and UHF field is generateable, receivable by the antenna of the transponder and by whose energy the microchip of the transponder is activateable.

12. A method for at least one of detecting and determining the concentration of an analyte using a biosensor, the method comprising:
bringing quartz oscillators, of an analysis unit of the biosensor, in contact with a sample to be examined;
activating a transponder of the analysis unit via an electromagnetic field generated by a reader device, and exciting the quartz oscillators to oscillate;
determining at least one of impedances and natural frequencies of the quartz oscillators; and
transmitting information regarding at least one of the impedances and the natural frequencies of the quartz oscillators to the reader device.

13. The analysis unit as claimed in claim 2, wherein the transponder comprises a microchip and an antenna.

14. The analysis unit as claimed in claim 3, wherein the transponder comprises a microchip and an antenna.

15. The analysis unit as claimed in claim 7, wherein the biopolymers include at least one of nucleic acids, proteins, peptides, polysaccharides, antibodies, antibody fragments, viruses and bacteria.

16. A biosensor for at least one of detecting and determining the concentration of an analyte, comprising:
an analysis unit as claimed in claim 2; and
a reader device, to interchange information with the transponder of the analysis unit via electromagnetic waves.

17. A biosensor for at least one of detecting and determining the concentration of an analyte, comprising:
an analysis unit as claimed in claim 3; and
a reader device, to interchange information with the transponder of the analysis unit via electromagnetic waves.

18. The biosensor as claimed in claim 9, wherein the reader device comprises an antenna by which at least one of an electromagnetic RF and UHF field is generateable, receivable by the antenna of the transponder and by whose energy the microchip of the transponder is activateable.

19. The biosensor as claimed in claim 10, wherein the reader device comprises an antenna by which at least one of an electromagnetic RF and UHF field is generateable, receivable by the antenna of the transponder and by whose energy the microchip of the transponder is activateable.

20. The method of claim 12, wherein the transmited information is information regarding at least one of whether and how many analyte molecules have bound to the capture molecules on the quartz oscillators.

21. A computer readable medium including program segments for, when executed on a computer device, causing the computer device to implement the method of claim 12.

22. A method for at least one of detecting and determining the concentration of an analyte using the biosensor of claim 8, the method comprising:
bringing quartz oscillators, of the analysis unit of the biosensor, in contact with a sample to be examined;
activating the transponder of the analysis unit via an electromagnetic field generated by the reader device, and exciting the quartz oscillators to oscillate;
determining at least one of impedances and natural frequencies of the quartz oscillators; and
transmitting information regarding at least one of the impedances and the natural frequencies of the quartz oscillators to the reader device.

23. A computer readable medium including program segments for, when executed on a computer device, causing the computer device to implement the method of claim 22.
